(19) United States
(12) Patent Application Publication
(10) Pub. No.: US 2006/0243402 A1
(43) Pub. Date: Nov. 2, 2006

(54) Shade roller assembly for shade rollers

(76) Inventor: Yu-Ming Chang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/116,237

(22) Filed: Apr. 28, 2005

(51) Int. Cl. E06B 9/56

(52) U.S. Cl. 160/321

(57) ABSTRACT

A shade roller assembly includes a rotatable mechanism connected to one of two extensions of a frame and a positioning assembly is connected to the other extension of the frame. A connection tube extends from the rotatable mechanism and is securely inserted in one end of a hollow roller. The other end of the hollow roller is connected to an insertion piece of the positioning assembly. Each of the connection tube and the insertion piece has two flanges which are engaged with one of six sides of the polygonal inner periphery of the roller. A shade body has an end thereof fixed to the roller and the roller includes six axial edge lines so that the end of the shade body is convenient to align with either one of the edge lines.

### FIELD OF THE INVENTION

The present invention relates to a roller assembly for shade rollers and the assembly is easily to be assembled and ensures the shade body is pulled horizontally.

### BACKGROUND OF THE INVENTION

A conventional roller assembly for shade rollers is shown in FIGS. 7 and 7A, and generally includes a frame 80 which includes two extensions on two ends thereof and the frame 80 is fixed on wall. A rotatable mechanism 83 is connected to one of the two extensions of the frame 80 and an elongate roller 82 has one end connected to the rotatable mechanism 83, the other end of the elongate roller 82 is connected to a positioning assembly on the other extension of the frame 80. The rotatable mechanism 83 includes a casing 831 and a rotatable member 832 is received in the casing 831. A connection tube 833 extends from the rotatable member 832 and has two first flanges 836 extending outward from an outer periphery of the connection tube 833. A bead chain drum 834 including a plurality of notches is mounted to the rotatable member 832 so as to be engaged with a bead chain 835. The roller 82 includes a protrusion 822 extending from an inner periphery thereof and the connection tube 833 extends into the roller 82 with the two first flanges 836 engaged with two sides of the protrusion 822. The positioning assembly includes an insertion 84 which is inserted into the other end of the roller 82 and two second flanges 843 extending from an outer periphery of the insertion 84 so as to be engaged with two sides of another protrusion 822 in the roller 82. A threaded stud 841 extends from an end of the insertion 84 and extends through a recess in the extension of the frame 80 so as to be connected to a nut 842 to fix the roller 82 between the two extensions of the frame 80. An end of the shade body 81 is securely connected to the roller 82 by screws.

However, when assembling the shade roller, the assemblers have to align the first and second flanges 836, 843 with the protrusions 822 in the roller 82 and this takes time. Besides, the assemblers need a wrench to tight the nut 842 to the threaded stud 841 and it requires the assemblers to raise their hands to rotate the nut 842 for a period of time, and this makes their arms pain. Furthermore, because the roller 82 is a circular tubular roller so that the assemblers have on axial reference line to check that the end of the shade body 81 fixed to the roller 82 is parallel to the axis of the roller 82.

The present invention intends to provide a roller assembly for shade rollers and the assembly effectively improves the shortcomings mentioned above.

### SUMMARY OF THE INVENTION

The present invention relates to a shade roller assembly that comprises a frame which has a first extension and a second extension extending perpendicularly from two ends thereof. A rotatable mechanism and a positioning assembly are respectively connected to the first and second extensions. A connection tube extends from the rotatable mechanism and has two first flanges extending from an outer periphery thereof. A hollow roller has a first end mounted to the connection tube and a second end of the roller is connected to the positioning assembly. The first flanges are engaged with a polygonal inner periphery of the roller. The positioning assembly has an insertion piece which is inserted in the second end of the roller and has two second flanges which are engaged with one of sides of the polygonal inner periphery of the roller. A shade body has an end thereof fixed to the roller.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the shade roller assembly of the present invention;

FIG. 2 is an exploded view to show the shade roller assembly of the present invention;

FIG. 3 is a cross sectional view to show the shade roller assembly of the present invention;

FIG. 4 shows that the positioning piece can be pushed into the insertion piece of the positioning assembly;

FIG. 5 shows the roller is rotated by pulling the bead chain;

FIG. 6 shows a stopper on the bead chain stops the movement of the bead chain,

FIG. 7 is an exploded view to show a conventional shade roller assembly; and

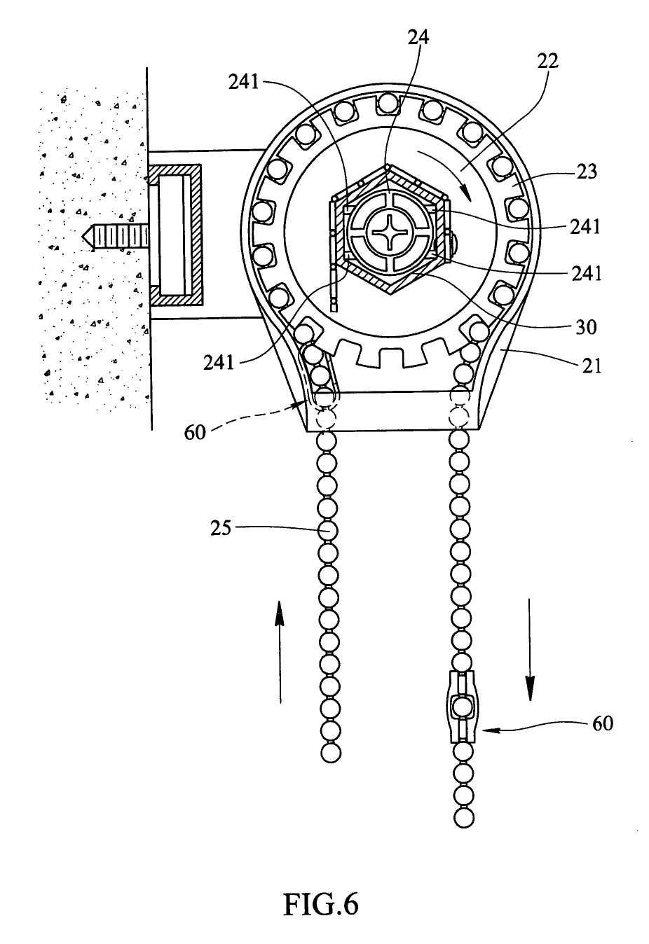

FIG. 7A is an elevational view of a conventional roller assembly.

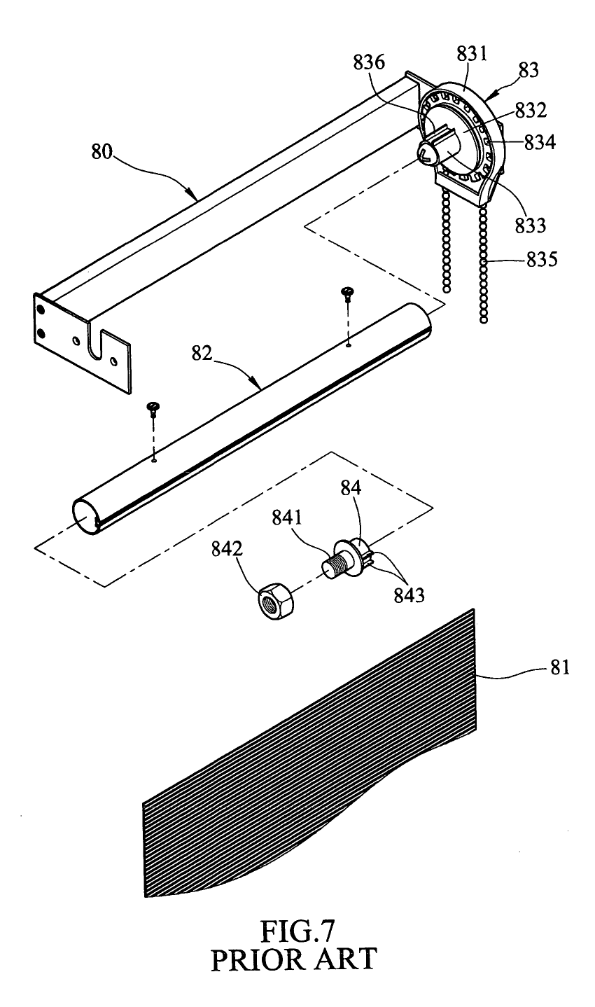

### DESCRIPTION OF THE PREFERRED EMBODIMENTS

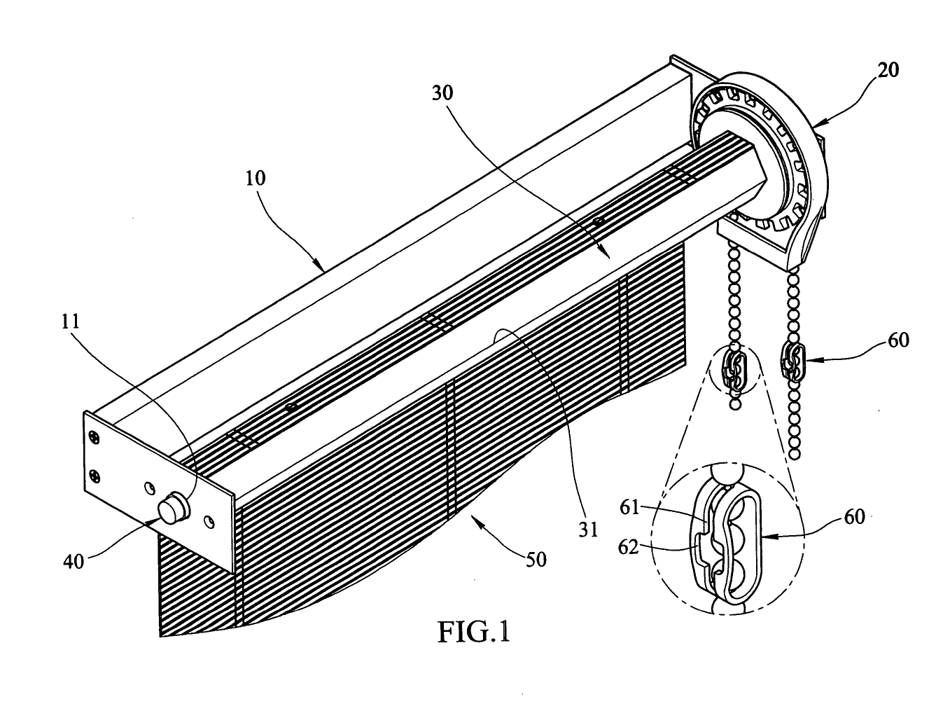

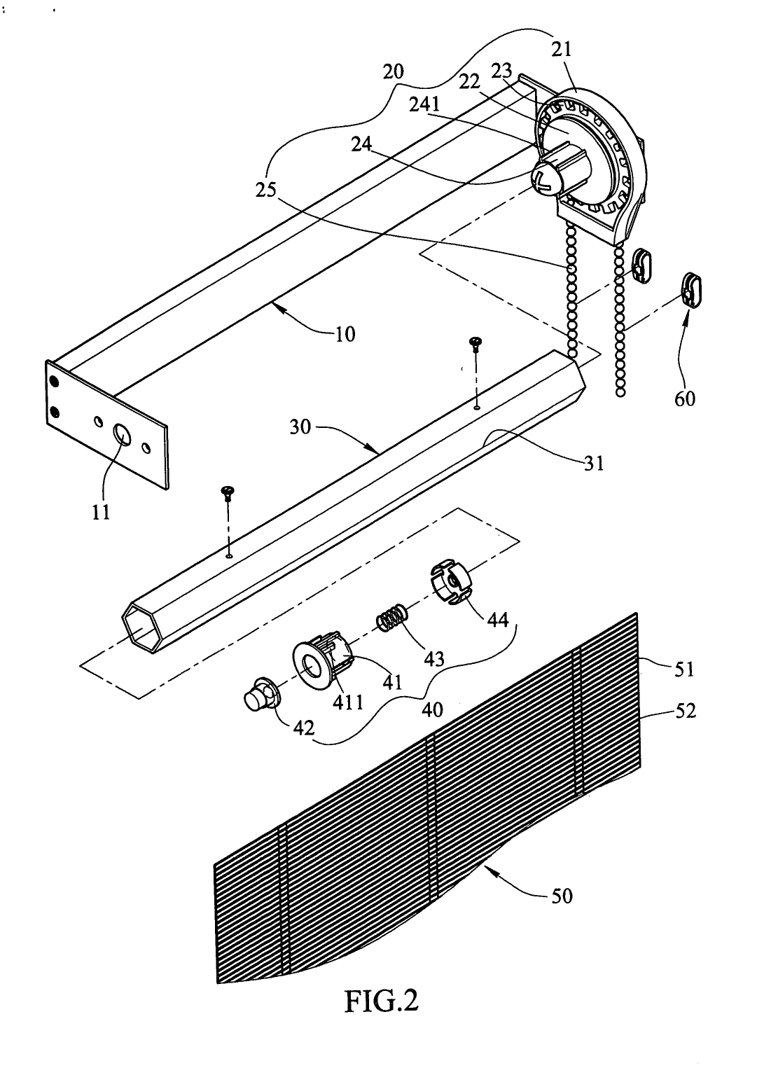

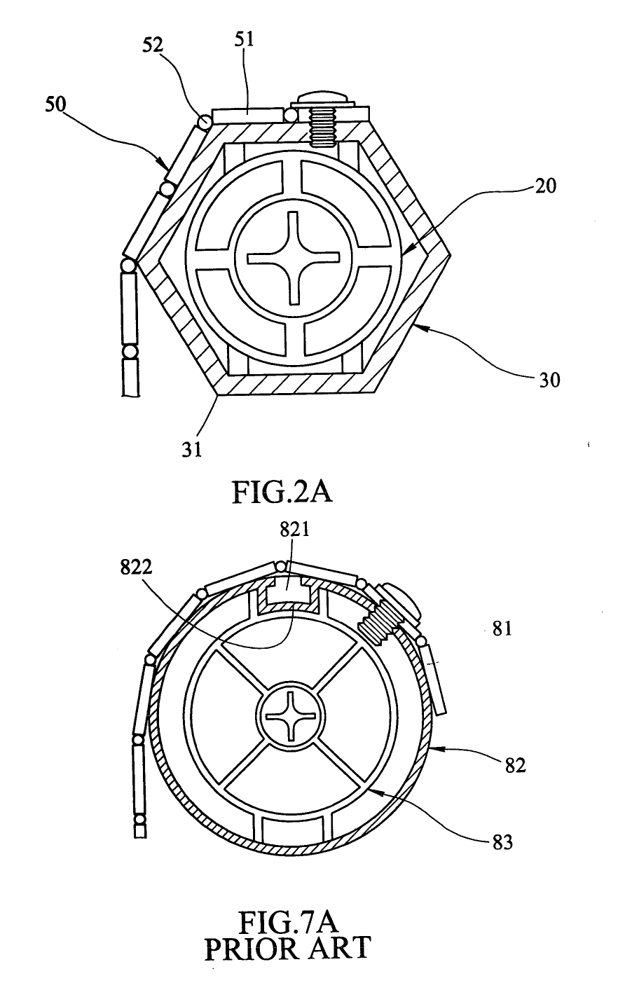

Referring to FIGS. 1 to 3, the shade roller assembly of the present invention comprises a frame 10 which is fixed on a wall and has a first extension and a second extension extending perpendicularly from two ends of the flame 10. A rotatable mechanism 20 is connected to the first extension and a positioning assembly 40 is connected to the second extension. The rotatable mechanism 20 includes a casing 21 with a rotatable member 22 connected thereto, a bead chain drum 23 is mounted to the rotatable member 22 and including a plurality of notches, and a bead chain 23 including a plurality of beads which are engaged with the notches of the bead chain drum 23. A connection tube 24 extends from the rotatable member 22. The bead chain drum 23 rotates the rotatable member 22 when the bead chain 23 is pulled. The connection tube 24 has two first flanges 241 extending from an outer periphery thereof.

A hexagonal hollow roller 30 has a first end thereof mounted to the connection tube 24 and a second end of the roller 30 is connected to the positioning assembly 40. A distance between the two first flanges 241 is the same as a width of each one of sides of the hexagonal inner periphery of the roller 30, so that the first flanges 241 are engaged with one of sides of a hexagonal inner periphery of the roller 30. An end of a shade body 50 is fixed to the roller 30. The roller 30 has a hexagonal outer periphery which includes six parallel axial edge lines 31 so that the end of the shade body 50 that is fixed to the roller 30 is easily to be in alignment with one of the axial edge lines 31. The shade body 50 is composed of a plurality of slats 51 which are connected by folding lines 52 therebetween so that the shade body 50 can be lifted upward or lowered by the folding lines 52.

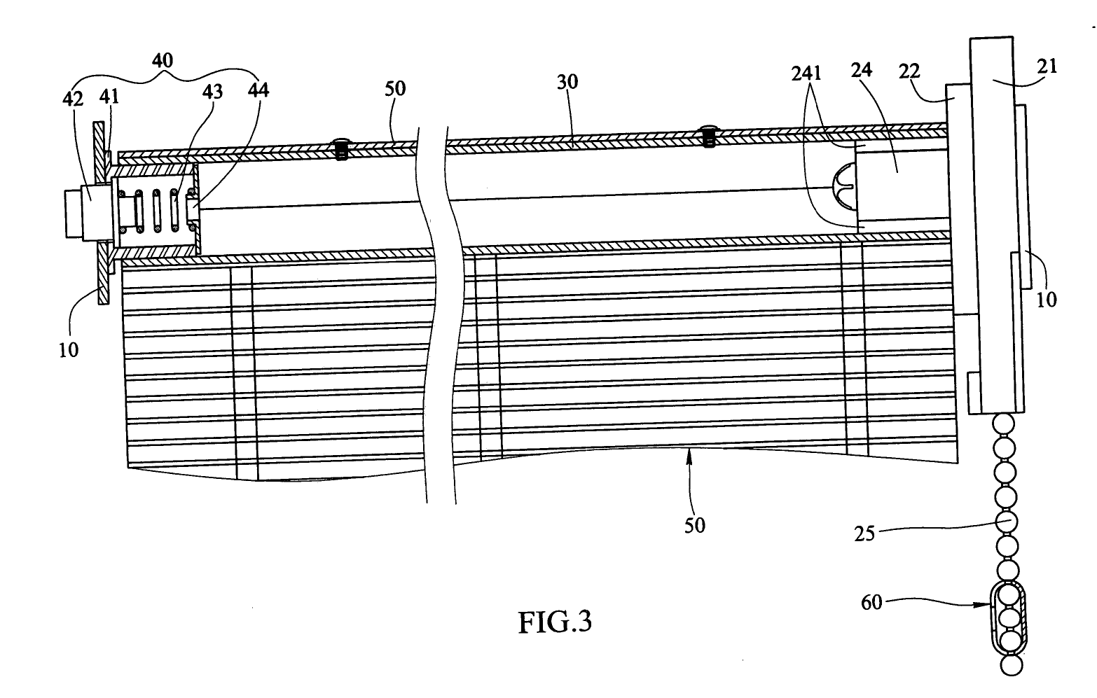

The positioning assembly 40 has an insertion piece 41 which is inserted in the second end of the roller 30 and two second flanges 411 extend from an outer periphery of the insertion piece 41. A distance between the two second flanges 411 is the same as a width of each one of the six sides of the hexagonal inner periphery of the roller 30. Therefore, the second flanges 411 are engaged with one of the six sides of the hexagonal inner periphery of the roller 30. The insertion piece 41 includes an axial passage in which a positioning piece 42 is engaged. The positioning piece 42 has a flange which prevents the positioning piece 42 from dropping from the insertion piece 41 so that an end of the positioning piece 42 can be extended from a first end of the insertion piece 41 and be engaged with a hole 11 in the second extension. A spring 43 is received in the axial passage of the insertion piece 41 and biases the positioning piece 42. An end cap 44 is connected to a second end of the insertion piece 41 to prevent the spring 43 from dropping from the insertion piece 41. By this arrangement, the assemblers simply pushes the positioning piece 42 inward when aligning the positioning piece 42 with the hole 11 of the second extension of the frame 10 as shown in FIG. 4, and then releases the positioning piece 41 which is pushed by the spring 43 and engaged with the hole 11.

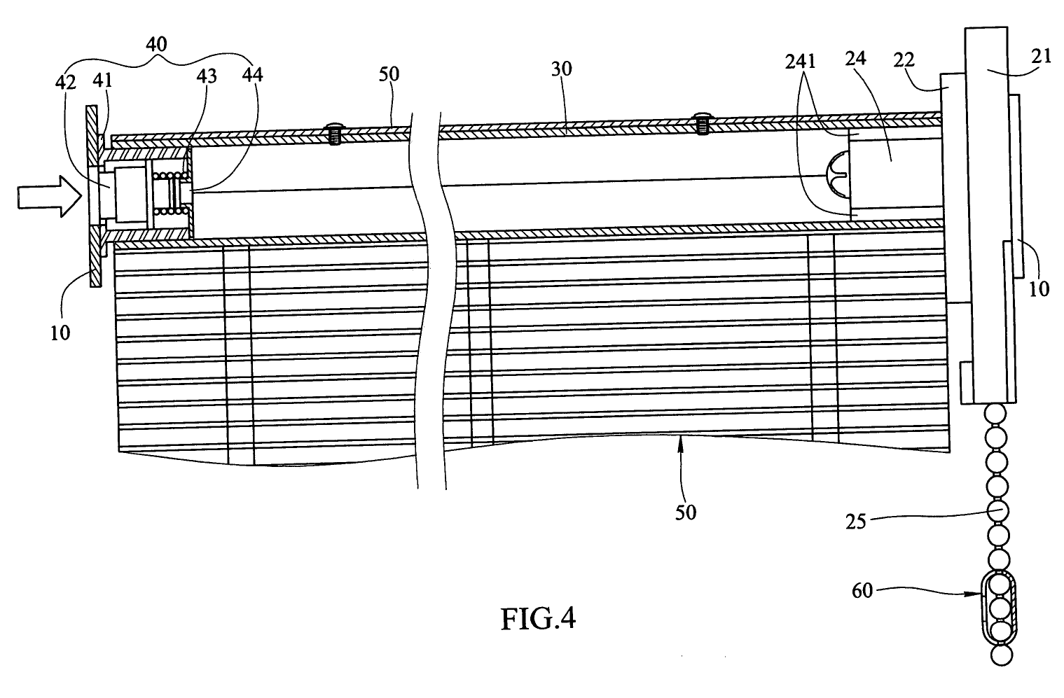

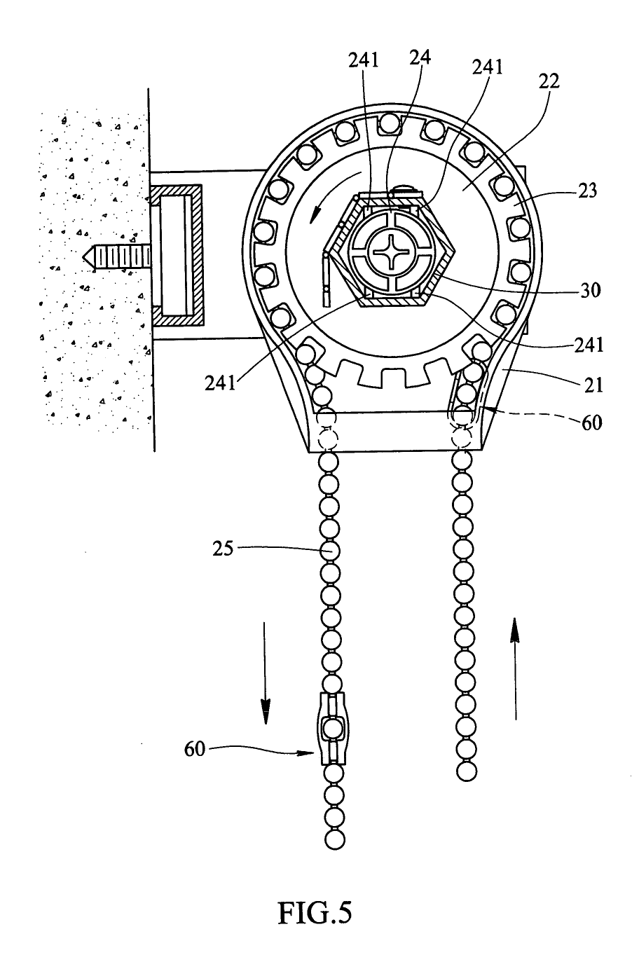

Further referring to FIGS. 5 and 6, two stoppers 60 are connected to the beads of the bead chain 25, the stoppers 60 each include a slot 61 (FIG. 1) and an enlarged opening 62 that is in communication with the slot 61 so that beads can be inserted in the stoppers 60 from the opening 62 and stopped at the narrower slot 61. When pulling the bead chain 25, one of the stoppers 60 is moved upward with the bead chain 25 on the right side of the rotatable mechanism 20 and the other stopper 60 is lowered with the bead chain 25 on the left of the rotatable mechanism 20. The rotatable member 22 is stopped by the up-rising stopper 60 when the stopper is blocked between the casing 20 and the bead chain drum 23. By this way, the users can set a pre-set distance that the bead chain 25 can be pulled.

While we have shown and described the embodiment in accordance with the present invention, it should be clear to those skilled in the art that further embodiments may be made without departing from the scope of the present invention.

What is claimed is:

1. A shade roller assembly comprising:
a frame having a first extension and a second extension extending perpendicularly from two ends thereof, a rotatable mechanism connected to the first extension and a connection tube extending from the rotatable mechanism, the connection tube having two first flanges extending from an outer periphery thereof;
a hollow roller having a first end thereof mounted to the connection tube and a second end of the roller connected to a positioning assembly which is connected to a second extension of the frame, the first flanges engaged with one of sides of a polygonal inner periphery of the roller, the positioning assembly having an insertion piece which is inserted in the second end of the roller, the insertion piece having two second flanges extending from an outer periphery thereof and the second flanges engaged with one of sides of the polygonal inner periphery of the roller;
a shade body having an end thereof fixed to the roller.

2. The shade roller assembly as claimed in claim 1, wherein the roller has a polygonal outer periphery which includes a plurality of parallel axial edge lines and the end of the shade body is in alignment with one of the axial edge lines.

3. The shade roller assembly as claimed in claim 1, wherein the rotatable mechanism includes a casing with a rotatable member connected thereto, a bead chain drum is mounted to the rotatable member and including a plurality of notches, a bead chain including a plurality of beads which are engaged with the notches of the bead chain drum, the connection tube extending from the rotatable member, the bead chain drum rotating the rotatable member so as to rotate the roller when the bead chain is pulled.

4. The shade roller assembly as claimed in claim 1, wherein the insertion piece includes an axial passage in which a positioning piece is engaged, the positioning piece extends from a first end of the insertion piece so as to be engaged with a hole in the second extension, a spring is received in the axial passage of the insertion piece and biases the positioning piece, an end cap is connected to a second end of the insertion piece to prevent the spring from dropping from the insertion piece.

5. The shade roller assembly as claimed in claim 1, wherein a distance between the two first flanges is the same as a width of each one of sides of the polygonal inner periphery of the roller.

6. The shade roller assembly as claimed in claim 1, wherein a distance between the two second flanges is the same as a width of each one of sides of the polygonal inner periphery of the roller.
